(19) United States
(12) Patent Application Publication
(10) Pub. No.: US 2009/0031766 A1
(43) Pub. Date: Feb. 5, 2009

(54) Object securing system

(76) Inventor: Anatoli Stobbe, Barsinghausen (DE)

Correspondence Address: COLLARD & ROE, P.C., 1077 NORTHERN BOULEVARD, ROSLYN, NY, 11576, US

(21) Appl. No.: 12/220,373

(22) Filed: Jul. 24, 2008

(30) Foreign Application Priority Data
Jul. 25, 2007 (DE) 10 2007 035 193.5
Nov. 4, 2007 (DE) 10 2007 052 911.4

(51) Int. Cl. E05B 65/00; E05B 17/00

(52) U.S. Cl. 70/263; 70/466

(57) ABSTRACT

An object securing system consisting of at least one station with docking, identification and registration means as well as objects fitted with compatible docking, identification and registration means is described.

The invention relates to an object securing system according to the preambles of claims 1 and 2.

Object securing systems are used, for example, in tourist centres in order to provide tourists with motor vehicles, in particular bicycles for individual excursions, against payment. For profitable operation, usage for the user should be as reliable and simple as possible and the fee to be paid should be dependent on the requirement, but misuse should be prevented. Further possibilities for use exist with mobile objects of all kinds such as transport containers.

It is the object of the invention to ensure reliable safe-keeping of the objects and simple and reliable recording and optional accounting of usage in an object securing system.

This object is achieved in an object securing system according to the preamble of the equivalent claims 1 and 2 by the features of the respective claims.

Further developments and advantageous embodiments are obtained from the dependent claims.

In the solution according to claim 1 or 2, an object can dock at a station by means of a combination of a flexible fixing proboscis fitted with a plug-in portion and a lock which receives the plug-in portion as well as an optional docking means. At the same time, it is registered and identified. The object cannot be removed or used by unauthorised persons, whereas authorised persons can open the lock by a release device by means of a user identity data carrier and/or input of an authorisation code and can use the object allocated to them.

In the docked state, a detection wafer containing registration data can be read by a reader. The detected registration data can be transmitted immediately or at a later time alone or in combination with data on the station, the user and times of usage of the station, to a user communication terminal or to a central unit. Exact logging and time-dependent accounting of usage are thereby possible.

The equivalent claims 1 and 2 merely differ in that in one case the detection wafer is disposed on the lock or in the vicinity of the lock or at the docking means or in the vicinity of the docking means and the reader or an antenna of the reader is disposed on the fixing proboscis and in another case, the arrangement is reversed.

According to a further development, the detection wafer in the plug-in portion of the fixing proboscis and the reader or read-write device or a read antenna of the reader or write-read antenna of the write-read device in the lock can be disposed in axial alignment or coaxially to the inserted plug-in portion. Alternatively, the reader or read-write device or a read antenna of the reader or write-read antenna of the write-read device in the plug-in portion of the fixing proboscis and the detection wafer in the lock can be disposed in axial alignment or coaxially to the inserted plug-in portion.

The data transmission component disposed in the plug-in portion is thus particularly well protected against damage, whether by use of vandalism and, on insertion into the lock or docking means, comes into the immediate vicinity of the data transmission component disposed in the lock or docking means. Secure, interference-free data transmission is thus ensured even at low transmission powers.

According to another further development, the detection wafer on a sleeve of the fixing proboscis or its plug-in portion on or near the connecting point between fixing proboscis and plug-in portion and the reader or write-read device or a read antenna of the reader or write-read antenna of the write-read device on the lock can be disposed close to the position of the sleeve when the plug-in portion is inserted. Alternatively, the reader or write-read device or a read antenna of the reader or write-read antenna of the write-read device on a sleeve of the fixing proboscis or its plug-in portion on or near the connecting point between fixing proboscis and plug-in portion and the detection wafer on the lock can be disposed close to the position of the sleeve when the plug-in portion is inserted.

It is thereby possible to use the flexible component of a commercially available chain or cable lock as the fixing proboscis without change or weakening its plug-in portion. Rather, the data transmission component assigned to the fixing proboscis can be attached subsequently to said fixing proboscis.

The fixing proboscis can be disposed on the station and the lock can be disposed on the object, wherein the docking means is formed by the lock itself.

By arranging the fixing proboscis on the station, said fixing proboscis can be configured to be particularly long and stable against vandalism without impairing the weight and the handling of the object after docking.

In another embodiment, the fixing proboscis and the lock can be disposed on the object and the docking means can be disposed on the station, wherein the docking means is formed by a sleeve through which the fixing proboscis passes.

By arranging the fixing proboscis on the object, the object can be docked at the station with the same fixing proboscis and can also be temporarily fixed to another fixed object capable of being looped around. The docking means of the station can be designed as an open plug-through sleeve. In the simplest case, this has no movable mechanisms which could wear or be liable to weathering influences.

In a further embodiment, the fixing proboscis can be disposed on the object and the lock can be disposed on the station, wherein the docking means is formed by the lock itself.

By means of this arrangement of the fixing proboscis on the object, the object can be docked at the station with the same fixing proboscis and can also be temporarily fixed to another fixed object capable of being looped around.

Finally, the fixing proboscis and the lock can be disposed on the station and the docking means can be disposed on the object, wherein the docking means is formed by a sleeve through which the fixing proboscis passes.

In this embodiment, the fixing proboscis remains at the station. In the simplest case, the sleeve on the object can manage without any movable mechanisms which could wear or be liable to weathering influences. In addition, the sleeve can be designed as a small light additional part which barely impairs the handling of the object as intended.

At least one writer connected to a user communication terminal or a central unit or at least one write antenna of the writer or at least one reader or at least one read antenna of the reader or at least one write-read device or at least one write-read antenna of the write-read device can be disposed in the sleeve of the docking means wherein, when the fixing proboscis is inserted into a coupling device, the writer or reader or write-read device is coupled to the controller from the plurality control, identification and registration circuit.

After plugging the fixing proboscis through the sleeve, a coupling device is located in the field of a reader or at least one read antenna of the read device or writer or at least one write antenna of the writer or a write-read device or at least one write-read antenna of the write-read device. All relevant data can be transmitted from and to the controller from the plurality control, identification and registration circuit by means of this coupling device.

Three writers or writing antennae of the writers or three readers or read antennae of the readers or three write-read readers or write-read antennae of the write-read devices can be disposed adjacent to one another in the sleeve of the docking means.

By means of three adjacently disposed writers or writing antennae of the writers or three readers or read antennae of the readers or three write-read readers or write-read antennae of the write-read devices, it can be reliably identified and distinguished whether the fixing proboscis has been plugged completely through the sleeve into the lock or has been inserted but then withdrawn or has only been briefly inserted and then withdrawn in order to merely grip the sleeve as far as the fixing in the lock for tampering purposes.

In this case, the sequence of gripped writers or writing antennae of the writers or readers or read antennae of the readers or write-read readers or write-read antennae of the write-read devices is evaluated. Only when a sequence 1, 2, 3 or 3, 2, 1 is maintained once, is the criterion for single insertion satisfied. Otherwise tampering is assumed.

The middle writer or the middle write antenna of the writer or the middle reader or the middle read antenna of the reader or the middle wrote-read device or the middle write-read antenna of the write-read device can be externally shielded in the sleeve.

By this means, effective data exchange between the detection wafer in or on the proboscis and the writer, reader or write-read device or its antennae in the sleeve can only be achieved when the proboscis is plugged through the sleeve but not when the proboscis is merely guided externally along the sleeve.

At least one detection wafer can be disposed in the sleeve of the docking means which, when the fixing proboscis is inserted, is temporarily connected to the quantity control, identification and registration circuit or when the fixing proboscis is inserted, is coupled by a coupling device.

Similarly to the variant with the writer, reader or write-read device or its antennae in the plug and the detection wafer in or on the fixing proboscis, in another embodiment when the fixing proboscis is inserted through the sleeve, the field of a writer, reader or write-read device or its antennae in the plug-in portion or a sleeve enters into the activation zone of a detection wafer. By this action all relevant data are transmitted and can be passed on to the coupled controller from the plurality control, identification and registration circuit.

Three detection wafers can be disposed adjacently to one another in the sleeve of the docking means.

Further, similarly to the variant with the writer, reader or write-read device or its antennae in the plug and the detection wafer in or on the fixing proboscis, by means of three adjacently disposed detection wafers, it can be reliably identified and distinguished whether the fixing proboscis has been plugged completely through the sleeve into the lock before engaging or has been inserted but then withdrawn or has only been briefly inserted and then withdrawn in order to merely simulate gripping through the sleeve as far as the fixing in the lock for tampering purposes. The evaluation is made similarly by means of the sequence of gripped-through detection wafers. Only when a sequence 1, 2, 3 or 3, 2, 1 is maintained once, is the criterion for single insertion satisfied. Otherwise tampering is assumed.

The middle detection wafer can be externally shielded in the sleeve.

Further, similarly to the variant with the writer, reader or write-read device or its antennae in the plug and the detection wafer in or on the fixing proboscis, effective data exchange between the detection wafer and the writer, reader or write-read device or its antennae can only take place when the proboscis is plugged through the sleeve but not when the proboscis is merely guided externally along the sleeve.

A plug-through block can be disposed in the sleeve, which is only temporarily releasable by an authorisation enquiry.

This prevents a user from inserting the fixing proboscis of an object into the wrong sleeve or fixing a conventional bicycle lock to the sleeve for sabotage purposes.

If a coupling device is provided between the writer, reader or write-read device or its antennae on the one hand and the controller from the plurality control, identification and registration circuit, the coupling device can disposed at, on or in the fixing proboscis and can be configured as a galvanic or inductive or capacitive coupling.

By means of this coupling device, coupling can also take place between the writer, reader or write-read device or its antennae on the one hand and the controller from the plurality control, identification and registration circuit, on the other hand when the writer, reader or write-read device or its antennae are not coupled to the controller over short distances but a coupling is only made via the fixing proboscis.

According to a further embodiment, a mono- or bidirectional data transmission path can be disposed between the controller from the plurality control, identification and registration circuit and a user communication terminal or between the controller from the plurality control, identification and registration circuit and a central unit or between the controller from the plurality control, identification and registration circuit and the central unit with the user communication terminal interposed as a relay station.

It is thereby possible to combine, compare or control the identification and registration data immediately with centrally administered authorisation and usage data, wherein storage capacity or own intelligence of the controller can be dispensed with.

The data transmission path can comprise a medium or a combination of media from the plurality wire line, glass fibre line, radio or physical data carrier to be transported from a reader or writer or write-read device to a reader or writer or write-read device.

Data exchange is thereby ensured in all cases depending on the available infrastructure.

In the case of the radio medium, remote interrogation or remote communication of the object is also possible. The object need not necessarily be docked directly at a station. Rather, it is sufficient to park it within the radio range of the station, either connected to a stationary external item of furniture, fenced-in in a free-standing manner or completely free-standing.

If mechanical fixing of the object is dispensed with, the presence of the object in the vicinity of the receiver or transmitting/receiving device of the station can be checked by means of a continuous or repeated interrogation of the registration date of the detection wafer.

The data transmission path comprises an encryption device.

Unauthorised reading of the data during the transmission is thereby made substantially more difficult.

Furthermore, the data can be stored in encrypted form on the detection wafer.

Unauthorised read-out of the data is thereby made substantially more difficult.

The release device can comprise an electromechanical drive which transfers a bolt into an unlocking position.

In this embodiment, the bolt can be unlocked automatically so that the user only needs to withdraw the fixing proboscis from the lock.

The release device can alternatively comprise a drive to be actuated manually which is coupled to the bolt by means of an electrically or electromagnetically activatable coupling and transfers the bolt into an unlocking position.

In this embodiment, only a low electrical energy is used for actuating the coupling whereas the substantially higher energy for actuating the bolt itself is applied manually by the user. As a result, when using a battery or a rechargeable battery as an energy source, a long running time for numerous actuation processes of the coupling can be achieved.

The release device can comprise a spring disposed in the lock which is compressed by the inserted plug-in portion and is released after transfer of the bolt into the unlocking position and automatically presses the plug-in portion from the lock.

This spring makes the handling easier when opening the lock since the user does not need a free hand for gripping and withdrawing the fixing proboscis.

The lock or the docking means can comprise a locking detection device.

It can hereby be detected whether and when an object has been returned to a station and at the same time docked and locked so that secure data transmission is made possible and misuse by unauthorised persons such as subsequent release of the object from the station is prevented.

Furthermore, the locking detection device can comprise a logical AND link evaluation circuit or program routine comprising readability of the detection wafer by the reader on the one hand and mechanical position of a bolt in a locking position or mechanical position of the plug-in portion in the lock on the other hand.

This further development makes it possible to achieve improved locking detection since it can be checked whether the plug-in portion of the fixing proboscis has been inserted into the lock or a fake having the same design.

Furthermore, it can be established in conjunction with the radio medium whether a user has parked the object for return and termination of use in the vicinity of a receiver of a station or is only randomly stopping there temporarily.

The release device can comprise an additional reader or write-read device for user identity data carriers and an evaluation device for identity data and when the identity data agree, the evaluation device generates a release signal or alternately a release signal and blocking signal.

The user can thus unblock or alternately unblock and block the release device with a user identity data carrier on the lock itself in a contactless manner. This eliminates any time-consuming telephoning of a central unit in some known object securing systems or the separate operation of a user communication terminal.

The electromagnetic drive can be activated by means of the user identity data carrier and the evaluation device, which drive transfers the bolt into an unlocking position.

Usage for the user is thereby further simplified since the bolt is also actuated in one operation.

The coupling can be activated by means of the user identity data carrier and the evaluation device, which coupling couples the drive to be actuated manually to the bolt.

In this embodiment, usage for the user is also further simplified since the coupling is activated in one operation so that the user can immediately actuate the bolt by actuating the manual drive.

The electrical or electronic components of the station or the object can be temporarily supplied via a time switch device by a battery or rechargeable battery and the time switch device can be switched on by a switching position of the drive to be actuated manually.

This feature has the result that the electrical or electronic components of the station or the object are only switched on as required and are automatically switched off again after a time delay has elapsed. In this way, the rechargeable battery or the battery is saved in the remaining time and the running time of the rechargeable battery or battery is substantially lengthened. The trigger for switching on is a switch position of the drive to be actuated manually.

The electrical or electronic components of the station or the object can be temporarily supplied via a time switch device by a battery or rechargeable battery and the time switch device can be switched on during insertion of the plug-in portion of the proboscis in the lock by means of a switching contact or by the locking detection device.

This feature likewise has the result that the electrical or electronic components of the station or the object are only switched on as required and are automatically switched off again after a time delay has elapsed. In this way, the rechargeable battery or the battery is saved in the remaining time and the running time of the rechargeable battery or battery is substantially lengthened. Here however, the trigger is the insertion of the plug-in portion of the proboscis in the lock.

A data carrier, as a registration and status data carrier, to be transported from a writer or reader or write-read device of a user communication terminal or a central unit to a writer or reader or write-read device of a controller from the plurality control, identification and registration circuit or a release device or in the reverse direction can be combined with the user identity data carrier.

Identity data are the object number, user identity number, optionally linked to an availability date as well as identity number of the detection wafer.

Registration data are, for example, station number, hire location, return location, duration of hire related to a bicycle hire station.

Status data are, for example, the kilometres travelled from which general usage can be inferred, as well as functions of the registration components or also of the lighting system and the tyre pressure if appropriate sensors are provided.

In the event that no wired or wireless connection exists between a user communication terminal or a central unit and a control, identification and registration circuit or release device, a mobile data carrier can be described and read as registration and status data carrier and can be physically transported instead of a wired or wireless connection. If this data carrier includes user identity data at the same time, the user can manage with a single data carrier which stores several types of data in combined form.

A lock which receives and locks the plug-in portion, which can be opened by an electromechanical release device or a key or actuating pin to be actuated manually can be additionally provided on the object or at the station.

By this means, the plug-in portion of the fixing proboscis not used for docking is not freely hanging but is fixed so that it is protected against weathering influences, vandalism and tampering.

The fixing proboscis can additionally be configured as a temporary object fixing device, wherein the lock disposed on the object comprises a key which is blocked against withdrawal when the plug-in portion of the fixing proboscis is not inserted in the object-side lock and is unblocked when the plug-in portion of the fixing proboscis is inserted, but is fixed against falling out, but is manually removable.

In this arrangement, the same fixing proboscis can be used for fixing on another object in addition to docking at a station. If the object is a bicycle, the fixing proboscis with the lock fulfils the function of a bicycle lock. So that the key to be used for this intended application is available on the object but cannot be removed by unauthorised persons, it is blocked against withdrawal when the plug-in portion of the fixing proboscis is not inserted in the object-side lock.

When the plug-in portion is inserted in the lock, two cases should be distinguished. In one case, the plug-in portion is merely inserted in the lock for safe-keeping during usage. In another case, the plug-in portion can be inserted into the lock for connecting the object to a fixed object such as clips, railings or masts. In both cases, the key could be removed. Whilst the key is removed during connection, it can remain in the lock during use. For safety, however, the unlocked key is fixed so that it cannot fall out due to vibrations.

When the plug-in portion of the fixing proboscis is not inserted in the object-side lock, the key is additionally recessed in a housing.

In additional to visual detection of the blocking, this also prevents unauthorised persons from being able to grasp the key by means of a tool and remove it by force.

A user communication terminal can comprise a display device, a read and/or input device from the plurality user data carrier, speech input or manual keypad input as well as a data storage device.

By means of these components, all instructions about user contract, contractual conditions, costs as well as operation of the object securing system can be given to a user on site at or near a station. Optionally, speech contact can also be made with a central unit. Furthermore, registration and status data of the objects can also be stored or buffered in the storage device as well as comparative data on user identity. In the event of transmission to a central unit, user data can be evaluated centrally for accounting, and object inventories at a station can be recorded and used for a logistic assignment of a surplus or minimum inventory.

The user communication terminal can additionally comprise an output and return device for user identity data carriers or combined registration, status and user identity data carriers.

By this means, the user can obtain or return the data carrier on site in the vicinity of a station and otherwise saves the necessary distance to the central unit.

The output and return device can comprise a read-write device for user identity data carriers or combined registration, status and user identity data carriers as well as an independent accounting device or a data transfer path to an accounting device of a central unit.

These features make it possible to keep blank data carriers in readiness in the user communication terminal which can then be individually written and read after return according to user, date, duration of withdrawal and object. On the basis of the written and read data, usage payments incurred can then be invoiced.

The data on the user identity carrier or the registration, status and user identity data carrier are preferably stored in an encrypted manner.

Unauthorised read-out or amendment of the data is thereby made substantially more difficult.

The user communications terminal can additionally comprise a reader or write-read device for cashless means of payment.

Additionally or alternatively, the user communications terminal can additionally comprise an input and exchange device for cash.

Both features make payment transactions for usage payments easier for the user and also make it possible to spontaneously hire objects.

The station or the user communication terminal or the station and the user communication terminal can comprise a mains-independent, preferably solar and/or wind-driven rechargeable-battery-assisted power supply.

It is thereby possible to have an installation which is directed towards user interests and which is independent of the power supply infrastructure.

The invention is explained hereinafter with reference to exemplary embodiments shown in the drawings. In the figures:

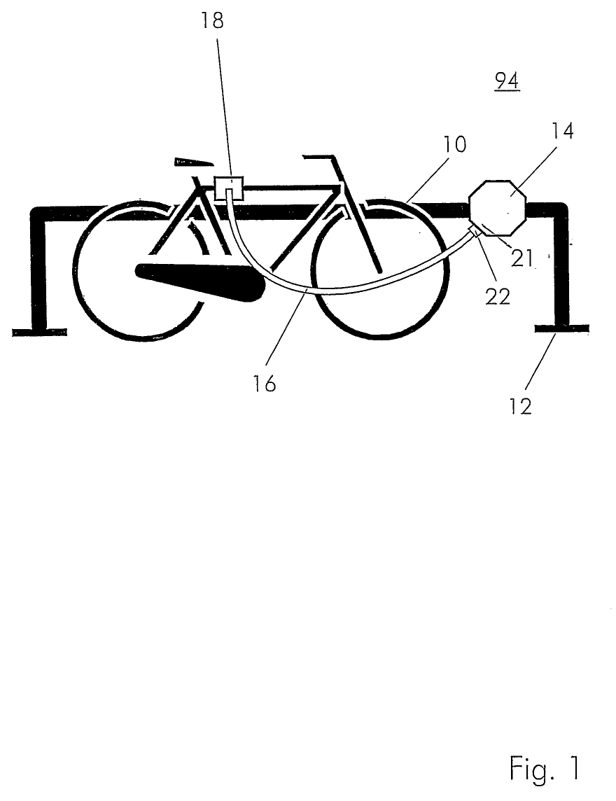

FIG. 1 shows a schematic diagram of an object docked at a station,

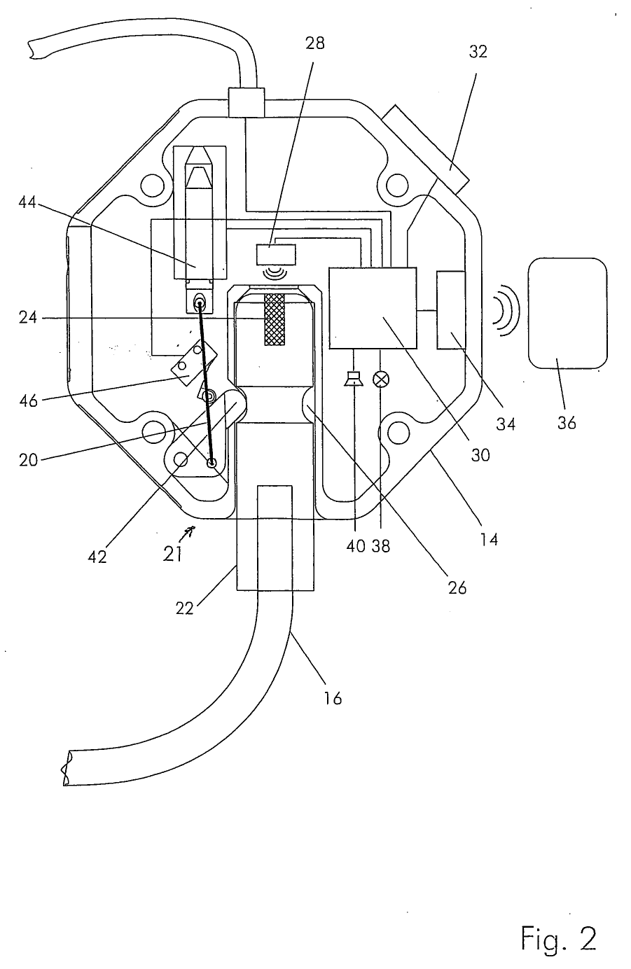

FIG. 2 shows a diagram of a docking, identification and registration means of a station,

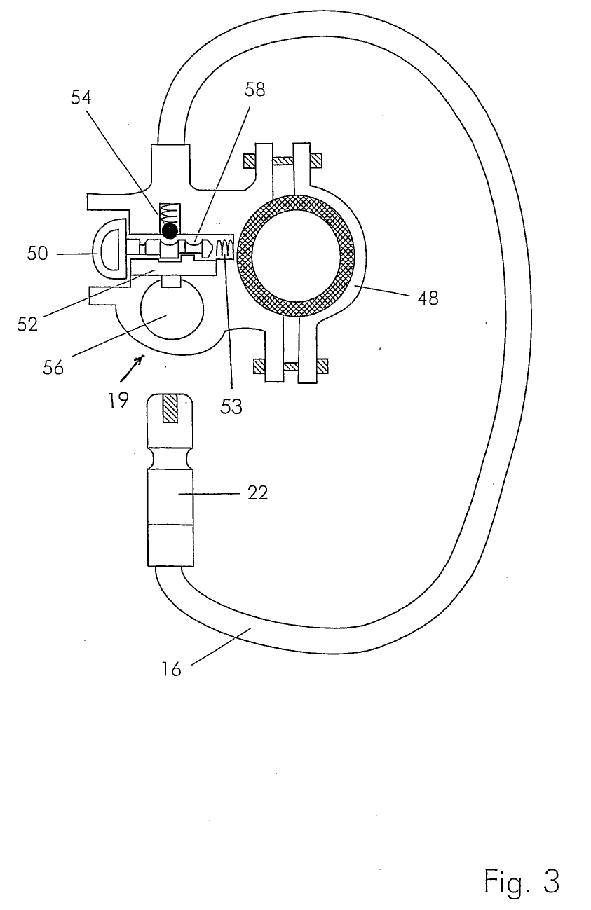

FIG. 3 shows a flexible fixing proboscis comprising a plug-in portion and a lock affixed to the object,

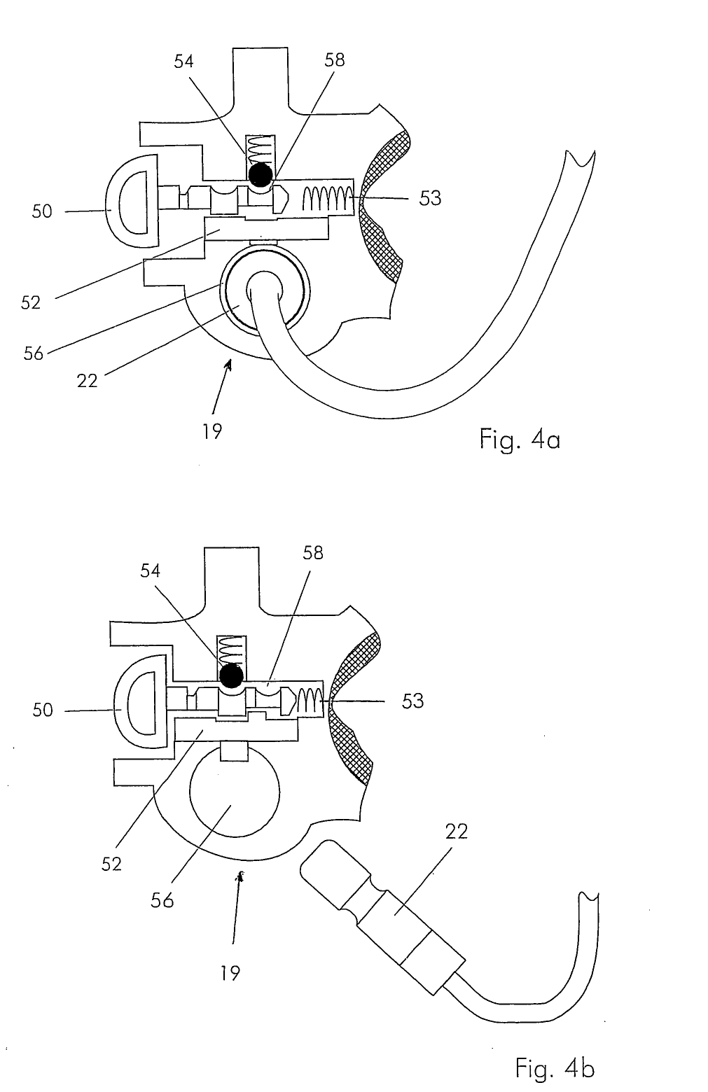

FIG. 4a shows a detailed view of the plug-in portion and lock in the open state,

FIG. 4b shows a detailed view of the plug-in portion and lock in the closed state,

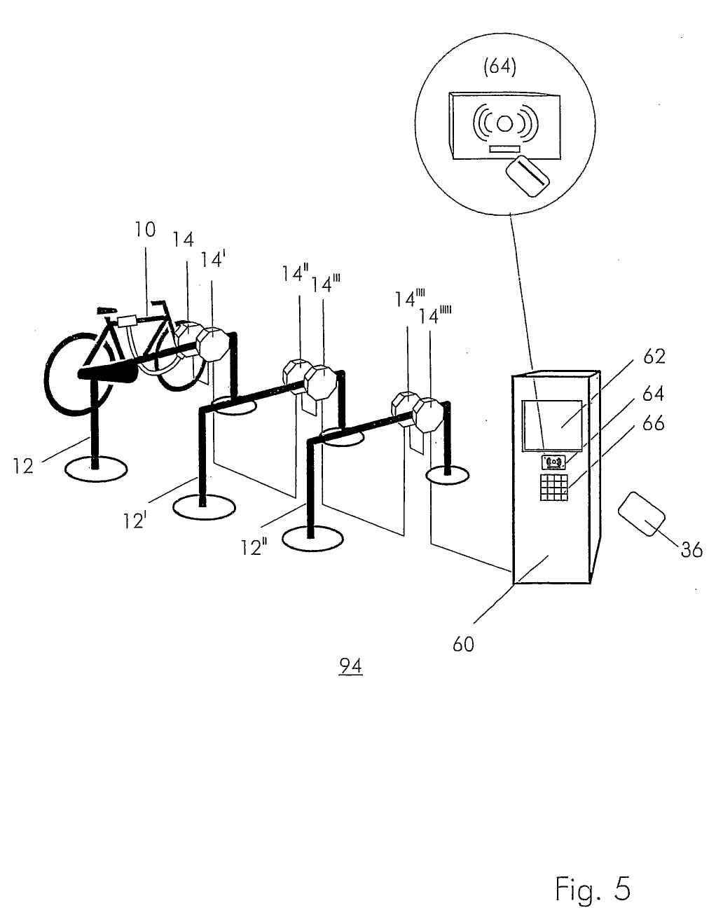

FIG. 5 shows a schematic diagram of a station with an object and a user communication terminal,

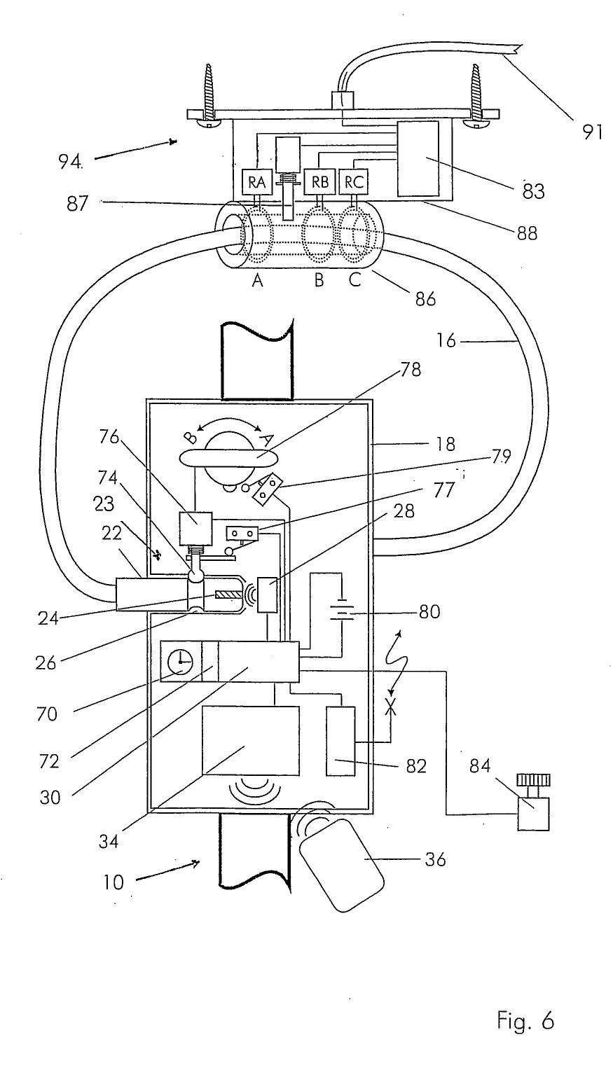

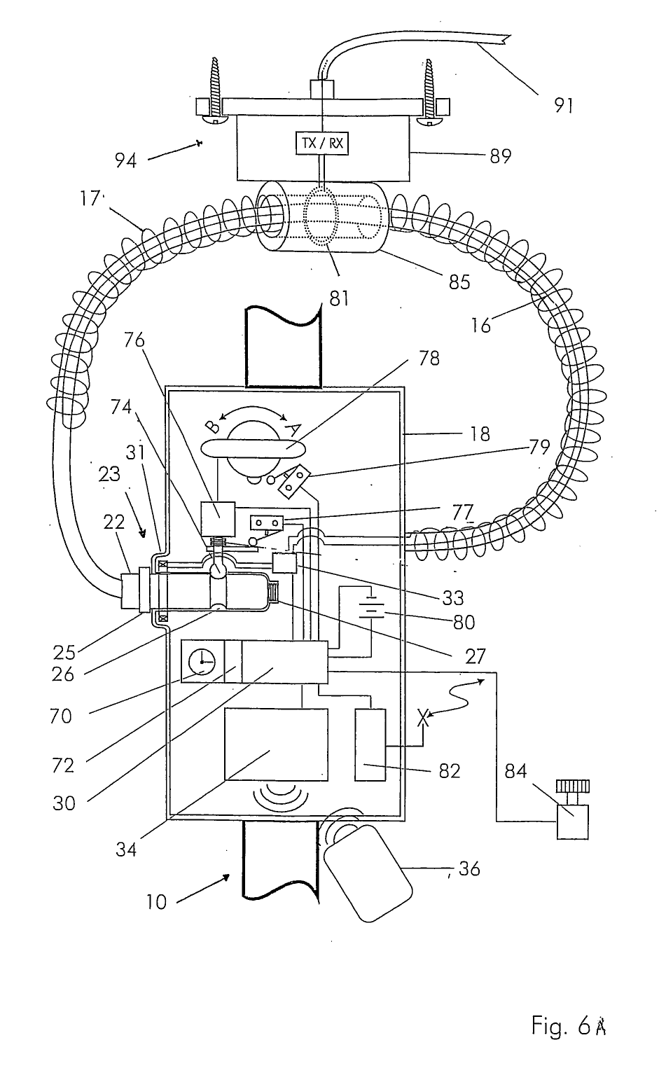

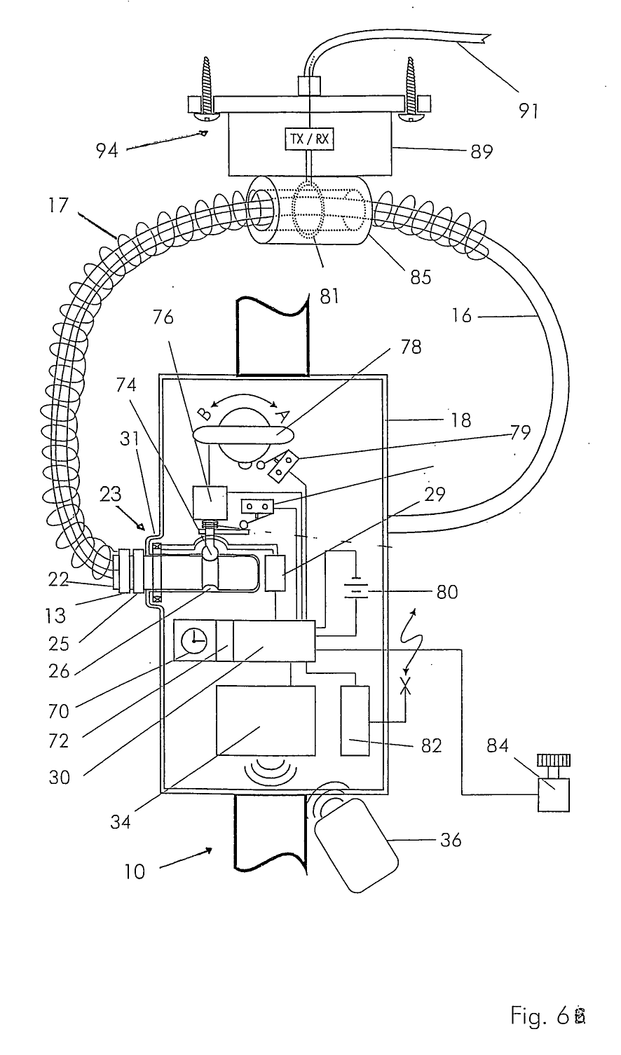

FIG. 6 shows an alternative diagram of docking, identification and registration means of a station and an object,

FIG. 6A shows a first modification of docking, identification and registration means of a station and an object according to FIG. 6,

FIG. 6B shows a second modification of docking, identification and registration means of a station and an object according to FIG. 6,

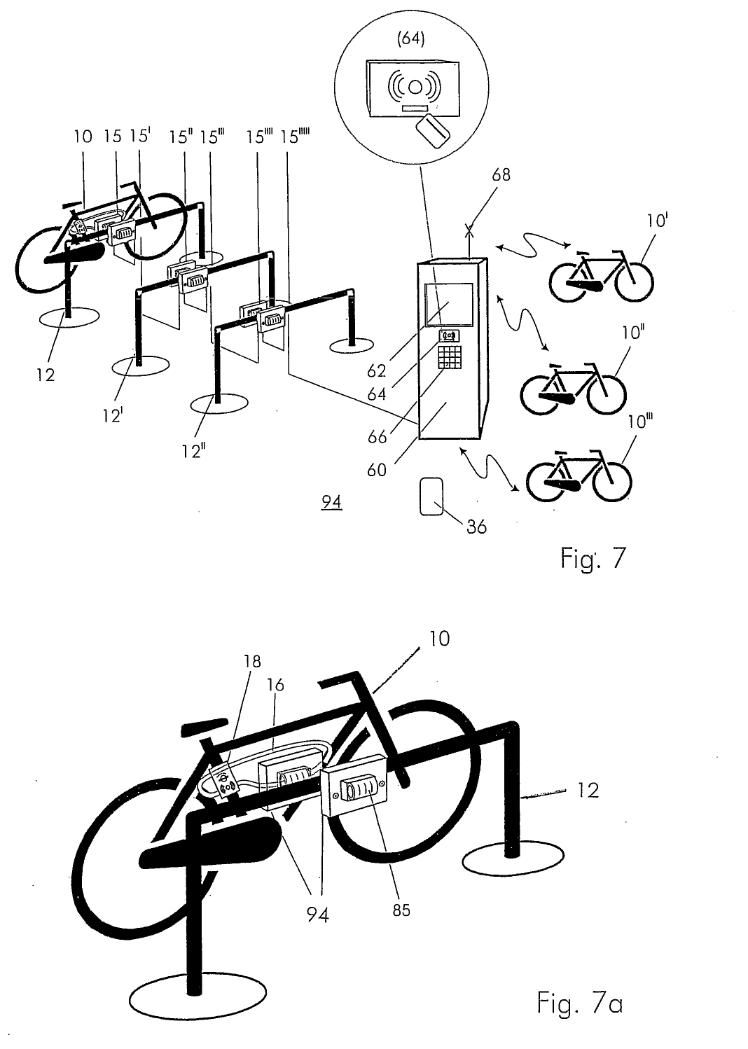

FIG. 7 shows an alternative diagram of docking, identification and registration means of a station with a plurality of objects;

FIG. 7a shows a detailed view of a detail from FIG. 7 and

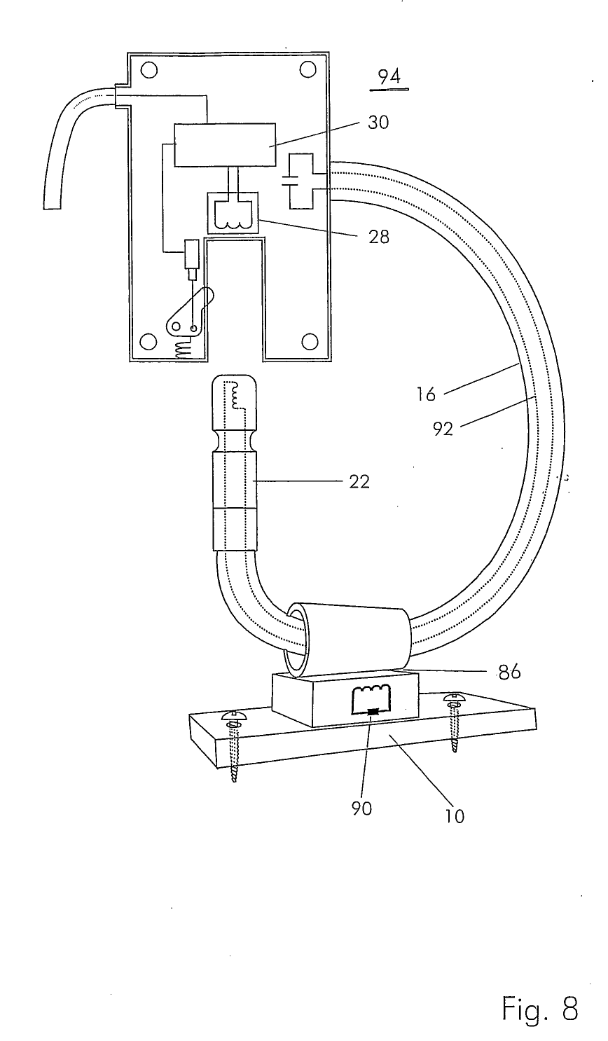

FIG. 8 shows another alternative diagram of docking, identification and registration means of a station and an object.

FIG. 1 shows a schematic diagram of an object 10 docked at a station 94. In the present case, the object 10 is a hire bicycle which is docked at a hire station. In this case, a flexible fixing proboscis 16 is fixed on a housing 18 on the hire bicycle, wherein a free end of the fixing proboscis 16 comprises a lockable plug-in portion 22 and is inserted in a lock 21 in a receiving housing 14 of the station affixed to a bicycle clamp 12.

FIG. 2 shows a diagram of a docking, identification and registration means of a station. A lock 21 for a plug-in portion 22 of a fixing proboscis 16 is located in a receiving housing 14. The plug-in portion 22 comprises a locating groove 26 as well as a detection wafer 24. The lock 21 comprises a bolt 42 which engages in the locating groove 26 of the plug-in portion 22, which is under spring tension and can be unlocked by means of an unlocking device 20 comprising an electromagnet 44. A locking detection device 46 configured as a switch or sensor makes it possible to detect the locking state of the lock 21.

Also located in the receiving housing 14 is a reader 28 which reads identity data of the detection wafer 24 disposed in the plug-in portion 22. Data of the detection wafer 24 are detected by means of a controller 30 and stored or transmitted to a central unit. Furthermore, the controller 30 together with a keypad 32 and/or a reader 34 for user data carriers 36 as well as the electromagnet 44 forms a release device for the plug-in portion 22 on authorisation of the user. In addition, a display device comprising LEDs 38 and a beeper 40 is connected to the controller 30, which signals various operating states.

FIG. 3 shows a flexible fixing proboscis 16 comprising a plug-in portion 22 and a lock 19 affixed to the object by means of a clip 48. Located in the lock 19 is a key 50 which, in the non-inserted state of the plug-in portion 22 in a receiving opening 56 in the lock 19, blocks against withdrawal by means of a bolt 52 and at the same time is recessed in the housing of the lock 19.

Detailed diagrams of the plug-in portion 22 and the lock 19 are shown in FIG. 4a for the open state and in FIG. 4b for the closed state. In the open, non-inserted state of the plug-in portion 22 in the receiving opening 56, an attachment of the key 50 is blocked by the bolt 52, in the closed, inserted state of the plug-in portion 22 in the receiving opening 56, the attachment of the key 50 is not blocked. A spring 53 presses against the key 50 in the fully inserted and recessed state. On lifting the blocking, the key 50 is pressed out by the spring 53 until a spring-loaded locating element 54 engages in a key groove 58 and fixes the key in this position so that it cannot fall out. Since the key 50 is then no longer recessed in the housing of the lock 19, the fixing effected by the locating element 54 can be manually overcome and the key 50 can be withdrawn as required.

FIG. 5 shows a schematic diagram of a station 94 with docking, identification and registration means 14 . . . 14″″′ on bicycle clamps 12, 12′, 12″ as well as a common user communication terminal 60. The docking, identification and registration means 14 . . . 14″″′ correspond to the embodiment in FIG. 2. The internal controllers not shown are connected to the common user communication terminal 60 that comprises a screen 62, a keypad 66 and a reader 64 for user data carriers 36 such as hire cards or credit cards. The user communication terminal 60 further includes a mains-independent, rechargeable-battery-supported power supply and a data transmission device to a central unit via a mobile radio network which, however, is not illustrated in the diagram.

FIG. 6 shows an alternative diagram of docking, identification and registration means of a station 94 and a mobile object 10. As in FIG. 2, a lock 23 for a plug-in portion 22 of a fixing proboscis 16, a reader 28 for detecting locking of the plug-in portion 22 and a controller 30 are located in a housing 18 disposed on a mobile object 10. The fixing proboscis 16 itself is likewise fixed on the object 10 or on the housing 18. The controller 30 further comprises a clock 70 and a storage device 72. The plug-in portion 22 has a locating groove 26 and a detection wafer 24. The lock 23 comprises a bolt 74 which engages in the locating groove 26 of the plug-in portion 22, which bolt can be unlocked manually by means of an interposed controllable coupling 76 by means of a toggle 78 by pivoting into a first pivot position in direction A when the controllable coupling 76 is activated by the controller 30. Furthermore, another reader 34 for user data carriers 36 is connected to the controller 30. A radio module 82 serves to transmit the status of the locking detection to a central unit or to the user communication terminal 60. A battery 80 or a rechargeable battery which can be charged by an object-side dynamo 84 is used for the power supply.

In order to extend the running time of the battery 80, the electrical and electronic components are switched off by the controller 30 in conjunction with the clock 70 after a time delay has elapsed. Only the clock 70 continues to run so that read data can be linked subsequently to the absolute time. Pivoting the toggle 78 into a second pivot position in direction B actuates a switch 79 which via the controller 30 switches on again the power supply for the electrical and electronic components until the power supply is interrupted again after the time delay has elapsed.

Another switch 77 is automatically actuated by means of the bolt 74 on insertion of the plug-in portion 22 and likewise serves to temporarily switch on the power supply. In addition, the position of the switch 77 in conjunction with a reading process of the detection wafer 24 by the reader 28 can be evaluated by the controller 30 as detection of locking.

A sleeve 86 having three adjacently disposed read antennae A, B, C of read receivers RA, RB, RC of a reader 88 is provided on the side of the station 94 and the fixing proboscis 16 passes therethrough. The sequence of the reading of the registration data of the detection wafer 24 on insertion of the plug-in portion 22 through the sleeve 86, is detected by a further controller 83 which is part of the reader 88. By evaluating the reading sequence, it is possible to determine whether the fixing proboscis 16 is still passing through the sleeve 86 after detection of the locking of the plug-in portion 22 in the lock 23 or has been inserted by bypassing the sleeve 86 after the plug-in portion 22 had previously been drawn through the sleeve again in the reverse direction. The detected data are passed from the controller 83 via a connecting cable 91 to a central unit or a user communication terminal.

An electromagnetically actuated locking pin 87 engages in the sleeve 86, forming an insertion block for impermissible fixing proboscis or other objects. When the plug-in portion 22 of a fixing proboscis 16 is guided towards the sleeve 86, the registration data of the detection wafer are read via one of the read antennae A or C and evaluated by means of the controller 83 and compared with comparative data which is stored or interrogated via the user communication terminal or the central unit. If the registration data agree with the comparative data, the blocking pin 87 is withdrawn from the sleeve 86 by means of the controller 83 so that the plug-in portion 22 can be inserted completely. Otherwise, the blocking pin 87 remains in the sleeve 86.

Instead of read antennae of a reader, detection wafers can also be disposed on the sleeve 86 if a reader were disposed in the plug-in portion instead of a detection wafer.

In addition to a mechanical fixing of the object 10 by means of the fixing proboscis 16 and a station 94, it is also possible to hold the object 10 mechanically unsecured in a closed area or completely freely accessible. For this purpose, the status of the locking detection as well as registration data of the detection wafer 24 must merely be repeatedly transmitted in a contactless manner to a user communication terminal to be able to monitor the presence of the object 10 in the reading range of the user communication terminal.

For unlocking the plug-in portion 22, the power supply should first be switched on by pivoting the toggle 78 in direction B and a valid user data carrier 36 coupled to the further reader 34 so that the coupling 76 is activated by the controller 30. The bolt 74 can then be removed from the locating groove 26 of the plug-in portion 22 by pivoting the toggle 78 in direction A.

FIG. 6A shows a first modification of docking, identification and registration means of a station 94 and a mobile object 10 compared with FIG. 6.

Located on the front face of an opening receiving the plug-in portion 22 in the lock is a spring 27 which is compressed by the locked plug-in portion 22 and after unlocking by the bolt 74, presses the plug-in portion 22 independently from the lock 23. A detection wafer 25 is located as a sleeve near the connecting point between the fixing proboscis 16 and the plug-in portion 22 on the plug-in portion 22 and a read antenna 31 is located at the wall of the housing 18 and encloses the opening in the lock 23 for the plug-in portion 22. When the plug-in portion 22 is inserted, the detection wafer 25 is located in the reading field of the read antenna 31. The read antenna 31 is connected to a write-read device 33 and the write-read device 33 is in turn connected to the controller 30.

Data between the controller 30 and a user communication terminal or a central unit are transmitted to the station 94 via a coupling device 17 comprising a write-read antenna wound around the fixing proboscis 16 and a write-read antenna 81 coupled thereto in the sleeve 85 as well as write-read devices 33; 89 connected thereto.

FIG. 6B shows a second modification of docking, identification and registration means of a station 94 and a mobile object 10 compared with FIG. 6 and FIG. 6A.

Here also a coupling device 17 comprising a write-read antenna wound around the fixing proboscis 16 is again provided. However, the write-read antenna is not directly connected to a write-read device 29 but goes over into a concentrated antenna section 13 near the plug-in portion 22, which section is in turn connected to the write-read device 29 via the write-read antenna 31. In this embodiment, data transmission between coupling device 17 and the write-read antenna 31 takes place in a contactless manner.

FIG. 7 shows an alternative diagram of docking, identification and registration means of a station 94 and objects. In addition to one object 10 which is fixed mechanically to one of the bicycle clamps 12, 12′, 12″, and is detected via identification and registration means 15, 15′; 15″, 15″′, 15″″, 15″″′, additional objects 10′, 10″, 10″′ are provided there which are not fixed mechanically to one of the bicycle clamps 12, 12′, 12″. These objects can be located in a closed region or completely freely accessible. The status of the locking detection as well as identification and registration data of the respective detection wafer 24 are transmitted or interrogated in a contactless manner via radio to the user communication terminal 60 as shown by an additional antenna 68 at the user communication terminal 60 and transmission symbols. In this case, only the presence of the objects 10′, 10″, 10″′ in the reception or radio range of the user communication terminal 60 is monitored.

FIG. 7a shows a detailed view of a detail from FIG. 7, i.e. a bicycle as object 10 on the bicycle stand or on the bicycle clamp 12. A housing 18 with the components shown in FIG. 6A or 6B and a fixing proboscis 16 which passes through a sleeve 85 on a station 94 is provided on the bicycle.

FIG. 8 shows an alternative diagram of docking, identification and registration means of a station 94 and an object 10. Unlike in the embodiments in FIGS. 6, 6A, 6B, 7 and 7a, the sleeve 86 is located on the object 10 and the fixing proboscis 16 with the lock 23 is located on the station 94. The sleeve 86 through which the fixing proboscis 16 passes has only one detection wafer 90. For reading the detection wafer 90, the fixing proboscis 16 is configured as a coupling device 92 and even when the plug-in portion 22 is inserted in the lock 23, makes it possible to read the detection wafer 90 via the read antenna 28 in conjunction with the reader 30 if the fixing proboscis 16 still passes through the sleeve 86.

The advantage of this embodiment is the simple structure of the object-side docking, identification and registration means which do not require a lock or a power supply but nevertheless allow reliable securing and monitoring.

1. An object securing system consisting of at least one station and at least one object, wherein the at least one station and the at least one object are fitted with at least one compatible docking means and the at least one station or the at least one object comprise identification and registration means, characterised in that on the at least one station or on the at least one object a plug-in portion of a flexible fixing proboscis is fixable in a lock which can be locked by a locking device but can be opened by a release device, and disposed on the fixing proboscis is a detection wafer containing identification and registration data and disposed on the lock or in the vicinity of the lock or on the docking means or in the vicinity of the docking means is a reader which reads data of the detection wafer or a reading antenna of the reader or a write-read device which writes and read data of the detection wafer or a write-read antenna of the write-read device and that the reader or write-read device is connected or coupled to a controller from the plurality control, identification and registration circuit.

2. An object securing system consisting of at least one station and at least one object, wherein the at least one station and the at least one object are fitted with at least one compatible docking means and the at least one station or the at least one object comprise identification and registration means, characterised in that on the at least one station or on the at least one object a plug-in portion of a flexible fixing proboscis is fixable in a lock which can be locked by a locking device but can be opened by a release device, and disposed on the lock or in the vicinity of the lock or on the docking means or in the vicinity of the docking means is a detection wafer containing identification and registration data and disposed on the fixing proboscis is a reader which reads data of the detection wafer or a reading antenna of the reader or a write-read device which writes and read data of the detection wafer or a write-read antenna of the write-read device and that the reader or write-read device is connected or coupled to a controller from the plurality control, identification and registration circuit.

3. The object securing system according to claim 1, characterised in that the detection wafer in the plug-in portion of the fixing proboscis and the reader or read-write device or a read antenna of the reader or write-read antenna of the write-read device in the lock are disposed in axial alignment or coaxially to the inserted plug-in portion.

4. The object securing system according to claim 2, characterised in that the reader or read-write device or a read antenna of the reader or write-read antenna of the write-read device in the plug-in portion of the fixing proboscis and the detection wafer in the lock are disposed in axial alignment or coaxially to the inserted plug-in portion.

5. The object securing system according to claim 1, characterised in that the detection wafer on a sleeve of the fixing proboscis or its plug-in portion on or near the connecting point between fixing proboscis and plug-in portion and the reader or write-read device or a read antenna of the reader or write-read antenna of the write-read device on the lock are disposed close to the position of the sleeve when the plug-in portion is inserted.

6. The object securing system according to claim 2, characterised in that the reader or write-read device or a read antenna of the reader or write-read antenna of the write-read device on a sleeve of the fixing proboscis or its plug-in portion on or near the connecting point between fixing proboscis and plug-in portion and the detection wafer on the lock are disposed close to the position of the sleeve when the plug-in portion is inserted.

7. The object securing system according to one of claims 1 to 6, characterised in that the fixing proboscis is disposed on the station and the lock is disposed on the object, wherein the docking means is formed by the lock itself.

8. The object securing system according to one of claims 1 to 6, characterised in that the fixing proboscis and the lock are disposed on the object and the docking means is disposed on the station, wherein the docking means is formed by a sleeve through which the fixing proboscis passes.

9. The object securing system according to one of claims 1 to 6, characterised in that the fixing proboscis is disposed on the object and the lock is disposed on the station, wherein the docking means is formed by the lock itself.

10. The object securing system according to one of claims 1 to 6, characterised in that the fixing proboscis and the lock are disposed on the station and the docking means is disposed on the object, wherein the docking means is formed by a sleeve through which the fixing proboscis passes.

11. The object securing system according to claim 8 and 10, characterised in that at least one writer connected to a user communication terminal or a central unit or at least one write antenna of the writer or at least one reader or at least one read antenna of the reader or at least one write-read device or at least one write-read antenna of the write-read device is disposed in the sleeve of the docking means and that when the fixing proboscis is inserted into a coupling device, the writer or reader or write-read device is coupled to the controller from the plurality control, identification and registration circuit.

12. The object securing system according to claim 11, characterised in that three writers or writing antennae of the writers or three readers or read antennae of the readers or three write-read readers or write-read antennae of the write-read devices are disposed adjacent to one another in the sleeve of the docking means.

13. The object securing system according to claim 12, characterised in that the middle writer or the middle write antenna of the writer or the middle reader or the middle read antenna of the reader or the middle wrote-read device or the middle write-read antenna of the write-read device are externally shielded in the sleeve.

14. The object securing system according to claim 8 or 10, characterised in that at least one detection wafer is disposed in the sleeve of the docking means which, when the fixing proboscis is inserted, is temporarily connected to the quantity control, identification and registration circuit or when the fixing proboscis is inserted, is coupled by a coupling device.

15. The object securing system according to claim 14, characterised in that three detection wafers are disposed adjacently to one another in the sleeve of the docking means.

16. The object securing system according to claim 15, characterised in that the middle detection wafer is externally shielded in the sleeve.

17. The object securing system according to one of claims 8 to 16, characterised in that a plug-through block is disposed in the sleeve, which is only temporarily releasable by an authorisation enquiry.

18. The object securing system according to one of claims 11 to 17, characterized in that the coupling device is disposed at, on or in the fixing proboscis and is configured as a galvanic or inductive or capacitive coupling.

19. The object securing system according to one of claims 1 to 18, characterised in that a mono- or bidirectional data transmission path is disposed between the controller from the plurality control, identification and registration circuit and a user communication terminal or between the controller and a central unit or between the controller and the central unit with the user communication terminal interposed as a relay station.

20. The object securing system according to claim 19, characterised in that the data transmission path comprises a medium or a combination of media from the plurality wire line, glass fibre line, radio or physical data carrier to be transported from a reader or writer or write-read device to a reader or writer or write-read device.

21. The object securing system according to one of claims 1 to 20, characterised in that the data transmission path comprises an encryption device.

22. The object securing system according to one of claims 1 to 21, characterised in that the data are stored in encrypted form on the detection wafer.

23. The object securing system according to one of claims 1 to 22, characterised in that the release device comprises an electromechanical drive which transfer a bolt into an unlocking position.

24. The object securing system according to one of claims 1 to 23, characterised in that the release device comprises a drive to be actuated manually which is coupled to the bolt by means of an electrically or electromagnetically activatable coupling and transfers the bolt into an unlocking position.

25. The object securing system according to one of claims 1 to 24, characterised in that the release device comprises a spring disposed in the lock which is compressed by the inserted plug-in portion and is released after transfer of the bolt into the unlocking position and automatically presses the plug-in portion from the lock.

26. The object securing system according to one of claims 1 to 25, characterised in that the lock or the docking means comprises a locking detection device.

27. The object securing system according to claim 26, characterised in that the locking detection device comprises a logical AND link evaluation circuit or program routine comprising readability of the detection wafer by the reader on the one hand and mechanical position of a bolt in a locking position or mechanical position of the plug-in portion in the lock on the other hand.

28. The object securing system according to one of claims 1 to 27, characterised in that the release device comprises an additional reader or write-read device for user identity data carriers and an evaluation device for identity data and that when the identity data agree, a release signal is generated by the evaluation device or alternately a release signal and blocking signal is generated.

29. The object securing system according to claim 28, characterised in that the electromagnetic drive can be activated by means of the user identity data carrier and the evaluation device, which drive transfers the bolt into an unlocking position.

30. The object securing system according to claim 28, characterised in that the coupling can be activated by means of the user identity data carrier and the evaluation device, which coupling couples the drive to be actuated manually to the bolt.

31. The object securing system according to one of claims 24 to 29, characterised in that the electrical or electronic components of the station or the object are temporarily supplied via a time switch device by a battery or rechargeable battery and the time switch device can be switched on by a switching position of the drive to be actuated manually.

32. The object securing system according to one of claims 25 to 31, characterised in that the electrical or electronic components of the station or the object are temporarily supplied via a time switch device by a battery or rechargeable battery and the time switch device can be switched on during insertion of the plug-in portion of the proboscis in the lock by means of a switching contact or by the locking detection device.

33. The object securing system according to one of claims 28 to 32, characterised in that the data carrier, as a registration and status data carrier, to be transported from a writer or reader or write-read device of a user communication terminal or a central unit to a writer or reader or write-read device of a controller from the plurality control, identification and registration circuit or a release device or in the reverse direction is combined with the user identity data carrier.

34. The object securing system according to one of claims 1 to 33, characterised in that there is additionally disposed on the object or on the station an additional lock which receives and locks the plug-in portion, which can be opened by an electromechanical release device or a key or actuating pin to be actuated manually.

35. The object securing system according to one of claims 8, 9, 11 to 34, characterised in that the fixing proboscis is additionally configured as a temporary object fixing device and that the lock disposed on the object comprises a key which is blocked against withdrawal when the plug-in portion of the fixing proboscis is not inserted in the object-side lock and is unblocked when the plug-in portion of the fixing proboscis is inserted, but is fixed against falling out, but is manually removable.

36. The object securing system according to claim 35, characterised in that when the plug-in portion of the fixing proboscis is not inserted in the object-side lock, the key is additionally recessed in a housing.

37. The object securing system according to one of claims 1 to 36, characterised in that a user communication terminal comprises a display device, a read and/or input device from the plurality user data carrier, speech inputs or manual keypad inputs as well as a data storage device.

38. The object securing system according to claim 37, characterised in that the user communication terminal additionally comprises an output and return device for user identity data carriers or combined registration, status and user identity data carriers.

39. The object securing system according to claim 38, characterised in that the output and return device comprises a read-write device for user identity data carriers or combined registration, status and user identity data carriers as well as an independent accounting device or a data transfer path to an accounting device of a central unit.

40. The object securing system according to one of claims 28 to 39, characterised in that the data on the user identity carrier or the registration, status and user identity data carrier are stored in an encrypted manner.

41. The object securing system according to one of claims 38 to 40, characterised in that the user communications terminal additionally comprises a reader or write-read device for cashless means of payment.

42. The object securing system according to one of claims to 41, characterised in that the user communications terminal additionally comprises an input and exchange device for cash.

43. The object securing system according to one of claims 1 to 42, characterised in that the station or the user communication terminal or the station and the user communication terminal comprises a mains-independent, preferably solar and/or wind-driven rechargeable-battery-assisted power supply.
